(19) United States
(12) Patent Application Publication
(10) Pub. No.: US 2025/0385582 A1
(43) Pub. Date: Dec. 18, 2025

(54) HOMOPOLAR TYPE GENERATORS AND MOTORS

(71) Applicant: NextPower360 Co., Leicester, NC (US)

(72) Inventor: Benedetto Anthony IACOVELLI, Leicester, NC (US)

(21) Appl. No.: 19/235,040

(22) Filed: Jun. 11, 2025

Related U.S. Application Data
(60) Provisional application No. 63/659,440, filed on Jun. 13, 2024.

(51) Int. Cl. H02K 31/02

(52) U.S. Cl. CPC H02K 31/02

(57) ABSTRACT

A homopolar dynamoelectric machine includes a hollow tube with an empty center, stator layers spaced radially apart from one another while being housed within the hollow tube, and at least one rotor layer provided within the hollow tube adjacent to the stator layers, and structured to be rotatable through a magnetic field generated by the stator layers. The at least one rotor layer and the stator layers are integrally connected to rotate together about a central axis of the hollow tube.

### CROSS-REFERENCE TO RELATED APPLICATIONS

The present application claims domestic priority to Ser. No. 63/659,440, filed on Jun. 13, 2024, the entire contents of which is hereby incorporated herein by reference.

### BACKGROUND OF THE INVENTION

### 1. Field of the Invention

The present invention relates to novel structures and systems for improvements to generators and motors. More specifically, the present invention relates to drum or disk homopolar machines which are able to be used to increase a power output per volume, field strength per magnet mass, and the voltage.

### 2. Description of the Related Art

The most commonly understood homopolar disk generator employs a disk spinning in, and at right angles to, a magnetic field. Often, that field is created by permanent magnets stationed on either side of the disc. Because of the Faraday paradox, the magnets can be stationary or spinning about the same axis as the disk and the unit still creates the same amount of power. Essentially the field can be thought of as stationary whether the magnets are stationary or spinning about their North/South axis.

From a physics standpoint, but for a single fatal flaw in the voltage to current ratio of the power output, homopolar electrical machines are nearly ideal for power production, low cost of manufacture, and operational reliability. The magnet poles are closer together, with a direct, straight flux path, creating a much stronger field. The field is perfectly oriented and does not bulge or cross-react as it does in conventional machines.

### SUMMARY OF THE INVENTION

To overcome the problems described above, example embodiments of the present invention provide new dynamoelectric motor and generator systems and structures that instantly and constantly adapt to the variability of an input or output rotational speed. There is no need for the heavy bulky and costly silicon steel laminations in many example embodiments of the present disclosure. The percent of the volume of the, for example, generator that is actively experiencing voltage induction is orders of magnitude higher than in conventional designs. The interaction between the rotor and the stationary magnetic field involves the entire rotor cutting all field lines simultaneously at any RPM above zero so that the generator starts creating power as soon as the rotor begins to move. The entire rotor is bathed in a perfectly ordered field such that the flux lines are always perpendicular to the rotor's motion. The rotor can be entirely immersed in this perfectly ordered, and very powerful field throughout its entire circumference, length and 360 degree rotation. No conventional generator comes close to these advantages.

According to an example embodiment of the present invention, a homopolar dynamoelectric machine includes a hollow tube with an empty center, stator layers spaced radially apart from one another while being housed within the hollow tube, and at least one rotor layer provided within the hollow tube adjacent to the stator layers, and structured to rotate through a magnetic field generated by the stator layers. The at least one rotor layer and the stator layers are integrally connected to rotate together about a central axis of the hollow tube. The above and other features, elements,

characteristics, steps, and advantages of the present invention will become more apparent from the following detailed description of example embodiments of the present invention with reference to the attached drawings.

### BRIEF DESCRIPTION OF THE DRAWINGS

FIG. 1 shows a cross section of a Faraday drum generator with the rotor immersed in the radial field and sandwiched between two stators according to an example embodiment of the present invention.

FIG. 2 shows a FEA diagram of a permanent magnet generator showing the longer flux path and smaller electroactive area represented by the paired circles.

FIG. 3a shows a drum homopolar machine according to an example embodiment of the present invention which is a hollow tube with an empty center.

FIG. 3b shows a drum homopolar machine including additional magnet layers and stator layers that function as additional generators according to an example embodiment of the present invention.

FIG. 3c shows a drum homopolar machine with thinner magnet and rotor layers according to an example embodiment of the present invention.

FIG. 4 shows an example embodiment of the present invention in which two thick magnets are divided longitudinally to create ½ size and ½ strength thinner magnets such that a same total space is divided into more magnet pairs with a total volume that remains unchanged.

FIG. 5 shows a comparison between homopolar machines, one having thinner magnet and rotor layers, according to an example embodiment of the present invention.

FIG. 6 shows an example of a rotor configuration according to example embodiments of the present invention.

FIG. 7 shows an example of a rotor configuration according to example embodiments of the present invention.

FIG. 8 shows a FEA diagram of a permanent magnet generator showing that only about 2% of the volume of the generator, the paired small circles, is the portion where EMF/electricity/torque is induced.

FIG. 9 shows a drum homopolar cross section showing an example embodiment of the present invention in which a rotor area, where electricity is induced, is about 30% of the volume.

FIG. 10 shows a Drum-homopolar device which includes enhanced conductivity magnets that function both as rotor and stator and a thin film insulation that allows the layers to be electrically connected in series corresponding to another example embodiment of the present invention.

FIG. 11 shows flux lines of a magnet corresponding to another example embodiment of the present invention.

### DETAILED DESCRIPTION OF EXAMPLE EMBODIMENTS

Example embodiments of the present invention will now be described with reference to the Drawings.

Example embodiments of the present invention are usable for dynamoelectric machines including electric motor applications as well as generator applications (e.g., the example embodiments of the present invention are applicable for any type of dynamoelectric machine). For the purpose of this disclosure the focus will be on drum and disk type example embodiments of homopolar type generators and motors, but the principles apply to all homopolar/designs in ways that are clear to those skilled in the art.

The most commonly understood homopolar disk generator employs a disk spinning in, and at right angles to, a magnetic field. Often, that field is created by permanent magnets stationed on either side of the disc. Because of the Faraday paradox, the magnets can be stationary or spinning about the same axis as the disk and the unit still creates the same amount of power. Essentially the field can be thought of as stationary whether the magnets are stationary or spinning about their North/South axis.

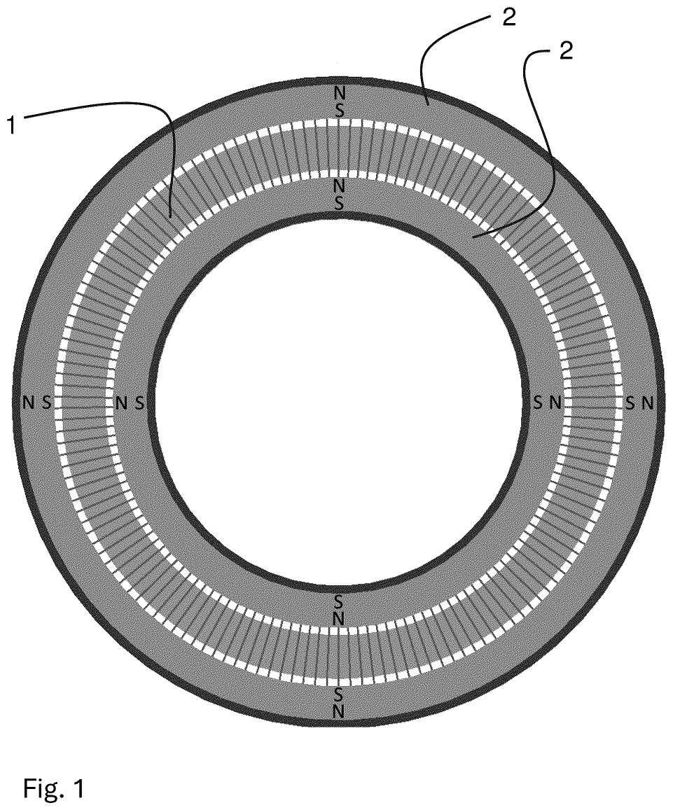

In the drum type arrangement, a conductive cylindrical drum serves as the rotor and it is most frequently concentrically sandwiched between radially magnetized larger and smaller diameter concentric cylindrical magnets. The cylindrical magnets create a radial field, in which the cylindrical rotor rotates. FIG. 1 shows a cross section of a Faraday drum generator according to an example embodiment of the present invention with the rotor 1 immersed in the radial field and sandwiched between 2 stators.

Just as in the disk variant, the same amount of power is generated in the drum type arrangement if the magnets of the stators 2 are stationary, or if the magnets and the stator 2 on which they are provided are rotating in place together with the rotor 1 around the longitudinal center axis of the drum. The same power output occurs because the magnetic field of the stator 2 functions as stationary magnetic field regardless of if the magnets of the stator 2 are rotating in the above manner or stationary. The rotor 2 physically rotates in the stationary magnetic field, transecting the flux, and creating EMF (Electro Magnetic Force).

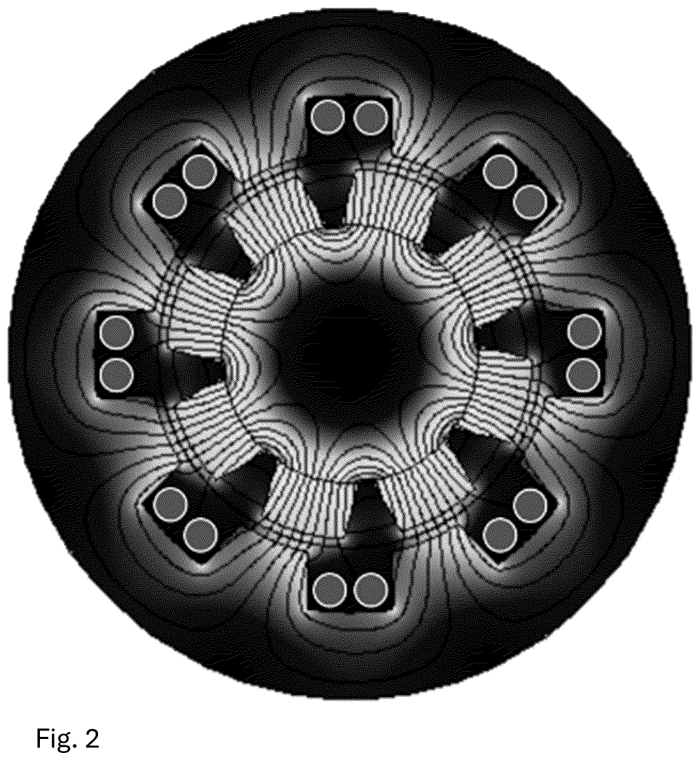

From a physics standpoint, but for a single fatal flaw regarding current and voltage power ratio (discussed in more detail below) which example embodiments of the present invention have overcome, homopolar electrical machines are nearly ideal for power production, low cost of manufacture, and operational reliability. The magnet poles are closer together, with a direct, straight flux path, creating a much stronger field. The field is perfectly oriented and does not bulge or cross-react as it does in conventional machines. There is no need for the heavy bulky and costly silicon steel laminations in many example embodiments of the present disclosure. The percent of the volume of the generator that is actively experiencing voltage induction is orders of magnitude higher than in conventional designs (an example of a conventional design being shown in FIG. 2).

The interaction between the rotor 1 and the magnetic field of the stators 2 involves the entire rotor cutting all magnetic field lines simultaneously at any RPM above zero so that the generator starts creating power as soon as the rotor 1 begins to move. The entire rotor is bathed in a perfectly ordered field such that the flux lines are always perpendicular or substantially perpendicular to the motion of the rotor 1. The rotor 1 can be entirely immersed in this perfectly ordered, and very powerful magnetic field throughout its entire circumference, length, and 360 degrees of rotation.

FIG. 2 shows a FEA diagram of a comparative example of a permanent magnet generator which includes a longer flux path and smaller electroactive area as compared to the Examiner embodiments of the present invention discussed above, as depicted by the paired circles of the flux lines of FIG. 2.

Homopolar type generators have such ideal utilization of the underlying physics considerations that an ideal device which would be small enough to fit inside a child's school backpack can make enough power to offset the needs of more than 32 homes. For example a 20 cm copper disc that is 3 cm thick spinning in a ½ Tesla field can create 65 KW of power at 1500 rpm.

The fatal flaw amid all this perfect application of physics laws is that even though a simple small homopolar disc generator creates a tremendous amount of power, the power produced has a poor power ratio including a tremendously high magnitude of amperage and disqualifying detrimental low magnitude of voltage. The above ideal disk, while making 65 watts, produces that power as a mere half of volt and a massive 125,000 amps. This form of power cannot run most machines and cannot be transmitted over distances. In fact, the voltage makes the output so exquisitely sensitive to even tiny resistances that just contact and brush losses alone are enough to stymie getting most of that power out of the generator. For the portion that makes it out of the generator, step up transformer requirements to raise the voltage from 0.5 volt to a useful/transmittable voltage are prohibitive.

As such homopolar structures have been essentially ignored except for a few niche applications such as rail guns and spot welding that use high amperage power.

Sliding contacts introduce resistance through a number of mechanisms. Contact resistance is due to two natural roughness of the interface of the two structures limiting the amount of surface area that is actually touching. Contact resistance is divided into multiple subcategories including constriction resistance and surface film resistance. Plus there are also impedance losses as the EMF is transmitted across the surface junction between dissimilar materials. The system voltage goes up with increasing RPM, but so does the resistivity of the sliding contacts. Conventional generators have a high enough voltage output that the effect of this resistance is negligible. However, Homopolar generators, with their markedly low voltage outputs are exquisitely sensitive to sliding contact resistance. A generator capable of producing thousands of watts may be read to be making only milliwatts because of the extreme sensitivity.

The solution-Fortunately homopolar devices have another advantage which is able to be used to allow for novel improvements that increase the power output per volume, field strength per magnet mass, and the voltage. If the voltage of the rotor can be increased, then the power loss due to resistances can be mediated. Below example embodiments of the present invention use the drum homopolar variant to show a step by step series of novel improvements that create those solutions.

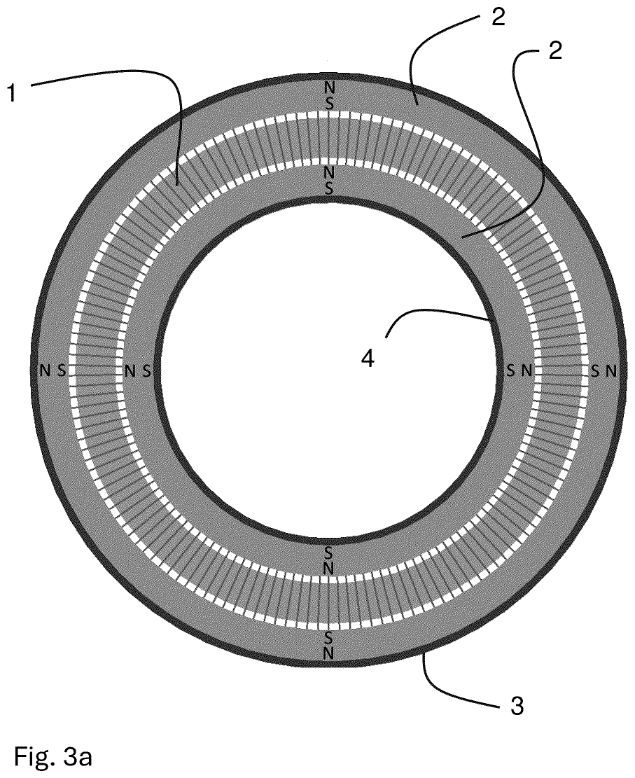

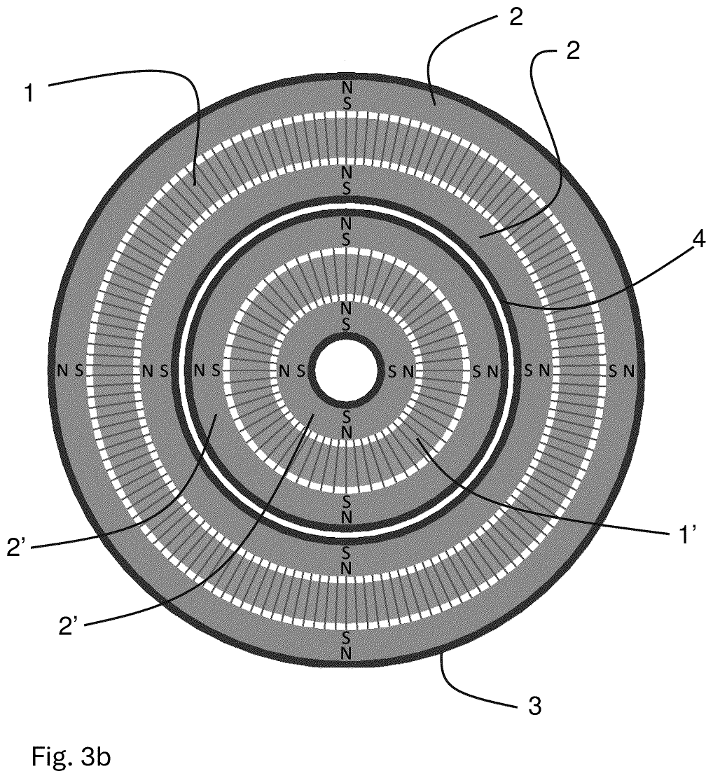

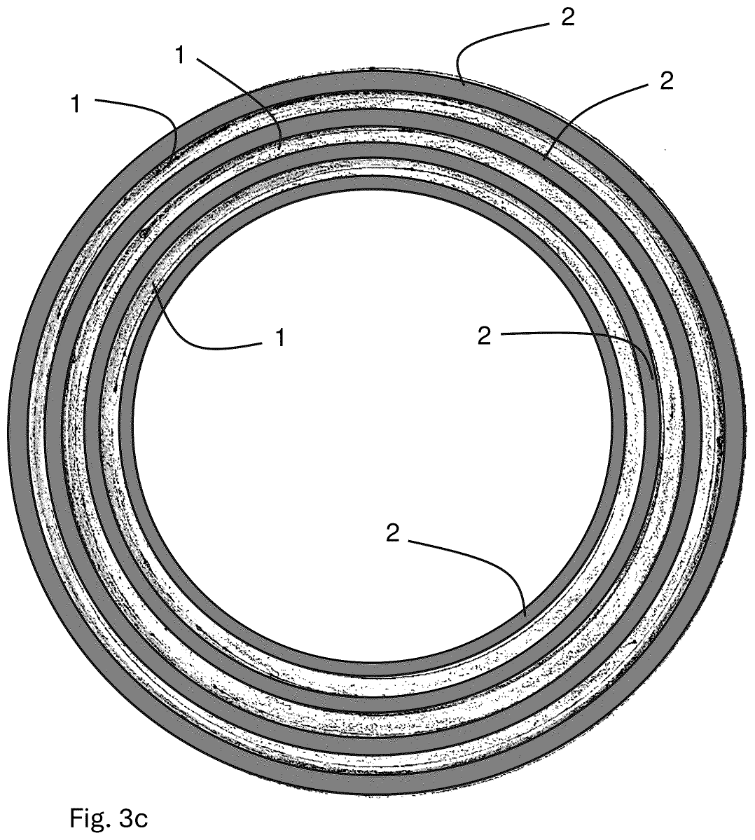

In a drum homopolar machine, because there is no need for the bulky laminations of silicon steel, the overall preferred morphology is often that of a hollow tube, for example. FIG. 3a shows a drum homopolar machine that is defined by a hollow tube 3 with an empty center 4. The overall cylinder wall in this case is preferably defined by one rotor layer 1 flanked by two stator layers 2. All the layers can be adhered together to rotate together monolithically, or could alternatively be provided separately with the rotor layer 1 rotating separately while the two stator layers 2 remain fixed, and the output is the same or substantially the same due to the Faraday Paradox as long as the rotor layer is rotating.

The hollow center 4 of the tube 3 can be filled by a second, smaller diameter drum homopolar machine, as shown in FIG. 3b. The hollow center can house additional rotor layers 1′ and stator layers 2′ that function as additional generators, for example. The additional generator can be structured to have an operating power generation range which peaks at a different RPM than that of the first generator creating adaptability to a wider range of RPMs. Also, now the magnets of each layer augment the field strength of the others.

If the magnet walls and rotor walls are made successively thinner, more and more layers of generators can be inserted into the system.

FIG. 3c shows an example embodiment in which thinner magnet 2 and rotor 1 layers allow many more additional generator units in the walls of the structure. These layers may be electrically connected in series to increase the voltage and/or in parallel to increase the amperage.

With the proper interspersing of either space or alternate pole flux manifolds between the generator functional assemblies (a functional assembly is a rotor 1 layer with flanking magnet layers 2), each or some functional assemblies can have opposite polarities as others so the EMF is created in different rotor layers is directed in opposing directions.

In disk based embodiments, the magnetic disks (e.g., stator disks) can be divided into thinner disks as can be the rotors. The rotor disks can also be divided into electrically distinct areas such as wedges that may be connected in series or parallel. If the rotor and stator disk sets vary by diameter, thickness, and magnetization energy each disk can be optimized to ramp up at a different rpm creating a generator that automatically implements the idea or substantially ideal generating capacity for the input of the prime mover. In cylindrical embodiments differential magnetization can produce the same effect, in addition to the variability range granted by the rotor layers having different diameters.

Because of the Faraday paradox, the rotors 1 do not have to spin freely from the stators 2 and it is also not necessary to include field-sapping large air gaps between the rotors 1 and stators 2. All these layers can even be adhered to one another to spin together while providing the net structural rigidity that very thin layers do not have. The rotors 1 and stators 2 become one or more monolithic/solid state structures. This lends itself to, for example, 3D printing and other specialized manufacturing processes. The field acts as a stationary field as is described by the faraday paradox and the rotor layers rotate through the stationary field inducing electricity to flow longitudinally (as opposed to circumferentially) in the rotors. The rotor layers can be connected, individually or in groups, in electrical series with one another to add the voltages. Longitudinal segments of the individual rotor layers can also be electrically isolated and electrically connected in series to increase the voltage. These modifications also increase torque production and efficiency when used in motor variants.

The rotor material is now divided into subsets that are electrically connected in series to increase the voltage for a generator and the torque and efficiency of a motor. The voltage and amperage output can be engineered simply by controlling the number of rotor segments connected in parallel vs in series. In an example embodiment of the present invention, it is possible for these connections io be altered electronically on the fly to modify output amperage to voltage ratios or torque as needed. The above feature is especially germane in systems that encounter variable operating conditions such as, for example, wind generators and electric vehicles. The system lends itself to a simpler hardier design with a much lower parts count requirement.

There are additional advantages in the above described example embodiments, in a magnetic field from two generators-one made with the 2 stationary magnets and rotating rotor and one made with equal mass and volume of magnet and rotor material but divided into interposed layers.

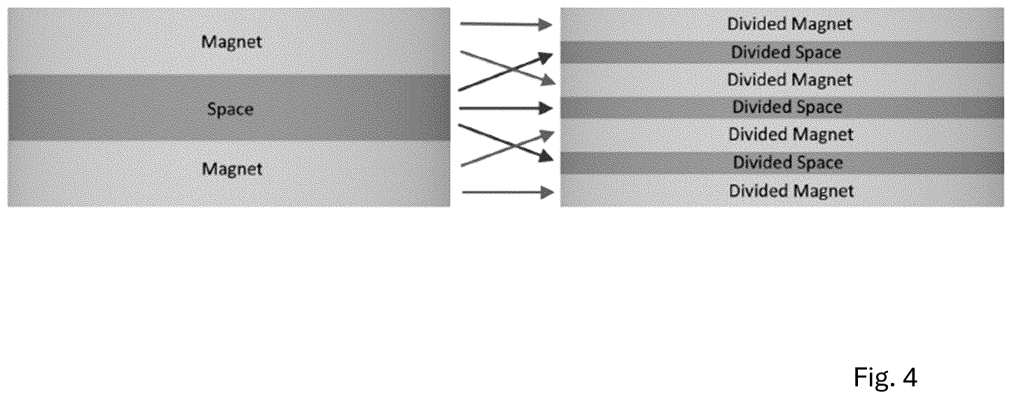

As shown in FIG. 4, it is possible to divide a pair of two thick magnets longitudinally to create pairs of ½ size to ½ strength thinner magnets such that a same total volume can be divided into more opposing pairs of thinner magnets. As a thick walled rotor cylindrical rotor is divided into several thinner walled cylindrical rotors that may add up to the same total the same mass of the original thick rotor. These thinner rotor layers are interspersed with thin magnet layers that may be thought of as subdivisions of the total mass of the 2 magnets that would flank the original single thick rotor. There are versions with more and less rotor and magnet mass, but this paragraph is about an apples to apples comparative field understanding. In this example, although the total rotor space (e.g., the divided spaces between the divided magnets) is the same and the total mass of magnet is the same, the field strength rises dramatically. This is because, even though thinner magnets have reductions in strength, the smaller magnets are closer together. Field strength rises by the 3rd power of the diminished distance between the magnets. Therefore field strength rises by much more from the reduced distance between the magnets, than it drops from the magnets being weaker.

When the large magnets on the left of FIG. 4 are replaced by several smaller magnet layers of equal total volume as shown on the right, and the total space between the magnets is kept the same in total but divided between the smaller magnets, the magnet field force in the spaces increases over that of the 2 larger magnets because the effect of the magnets being closer together overwhelms the lower strength of the smaller magnets.

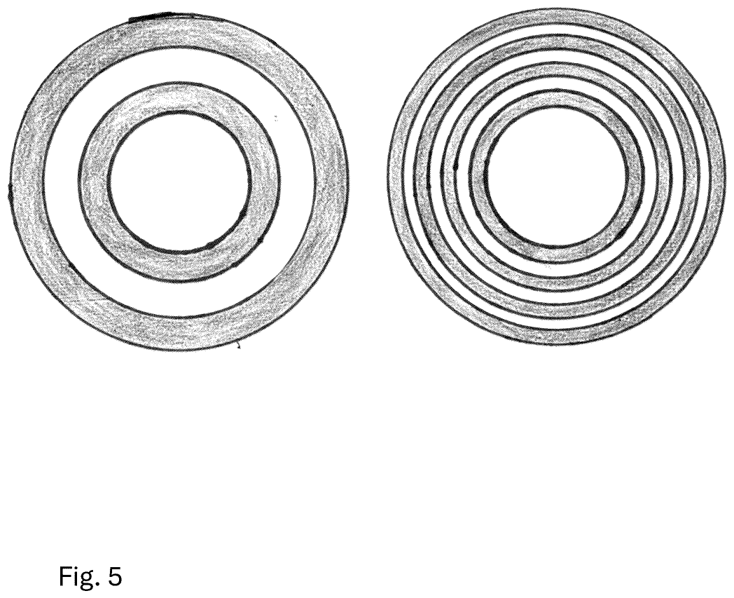

FIG. 5 shows an example embodiment in which the circumferential magnets on the left are replaced with 2 half thickness magnets on the right. In this case, the overall volume, the Inner Diameter and Outer Diameter, the total magnet volume and the total volume of space between the magnets is preserved as much as possible to show the improvement in magnet spacing. Each of the thinner individual magnets on the right of FIG. 5 have about half the strength the ones one left, but the field strength between the magnets (e.g., where the rotor is located) is increased because the distance between the individual magnets is less and the magnets share flux. An additional boon to the field strength is realized because there is no need for a large air gap between the rotors and the magnets.

In example embodiments, the rotor and magnet surfaces could even be touching and/or adhered to each other. For the purpose of this disclosure, the “stator” refers to components of the machine which produce the magnetic field which is stationary regardless of the axial rotation of the magnets. As long as the rotor layer is rotating with respect to the magnetic field, it makes the same power regardless of the rpm of the magnets. As such, thinner layers can be adhered together monolithically to create a pooled integral structure. In these embodiments they may co-rotate, including by being bonded together. The “rotor” refers to the layer with conductive material and the stator layer being the layer that contributes the magnetic field.

The above-described embodiments in which the rotor metal is partitioned from a thick rotor cylinder into several thinner concentric layers which are connected in series is not the only way the rotor can be segmented. For example, the rotor cylinders can be divided into electrically separated wedge segments. These segments may also be electrically connected in series or in parallel.

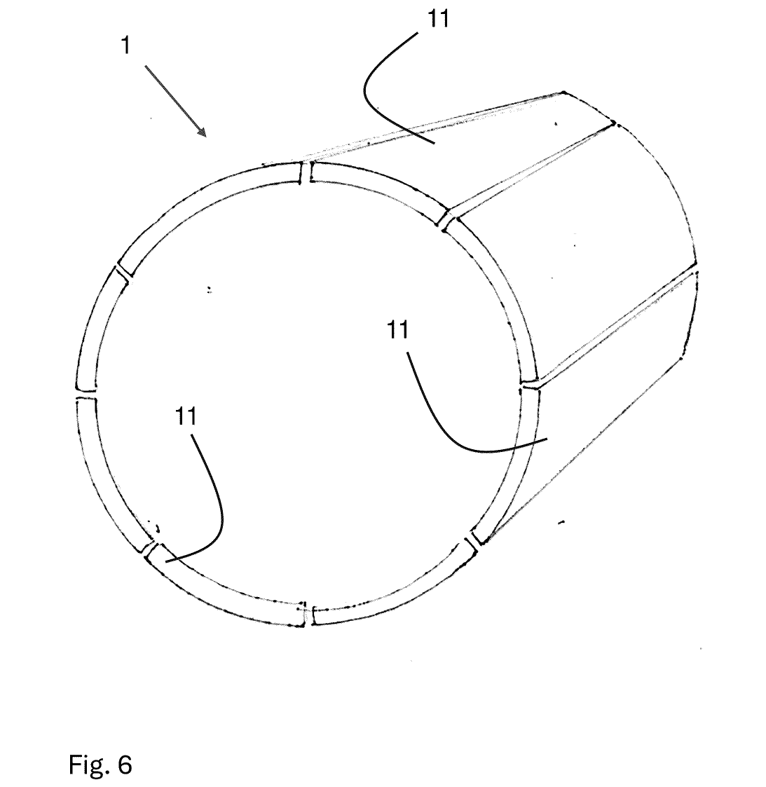

FIG. 6 shows an example embodiment in which the rotor layer 1 may be divided into electrically distinct sections 11 that can be electrically insulated from each other except to be electrically connected in series when additional voltage is desired, and in parallel when additional amperage is the goal. An electrical control can make the connection changes when the output requirements vary.

In a motor, especially, there is a need to provide longitudinal divisions in the rotor function to prevent detrimental circumferential eddy currents which weaken power generation. There are many additional ways that the rotor layer can be divided for series/parallel connection.

Any desirable form of magnet may be used for the stator 2, such as, creating a radial field from iron nitride magnets. Iron nitride magnets can be twice as strong as Ferrite and theoretically could even be 4 to 5 times as strong as Ferrite. Iron nitride could also be used to make thin film magnets.

For very thin stator layers, the flux of a stator magnet layer largely pairs additively with the flux from other stator magnet layers to create a powerful flux field which in cylindrical embodiments may be a radial field. In cylindrical embodiments, the outer magnet layers are larger than the inner magnet layers because of the increased circumferences. If the magnets are the same strength and thickness, the outer layers make more flux than a pair with the smaller amount of flux from the relatively smaller central stator magnet layers can. Some of the surplus flux will simply pass through the inner layers unpaired, but some may stray laterally to return without passing through the inner layers. This stray lateral surplus flux represents wasted potential. Some example embodiments of the present invention mediate the issue by providing inner magnets that are stronger in proportion to their reduced circumference so as to provide an equal amount of flux as the outer layers. This can be achieved in many ways, including, but not limited to, making the inner magnets thicker, making the magnets of a stronger mixture of materials, or magnetizing the magnets more strongly, or using hybrid electro/permanent magnets. Another way to address the issue is the use of rotor materials in portions closer to a longitudinal center of the rotor that include a relatively higher magnetic permeability, while keeping the ends of the rotor less permeable, for example, by keeping the ends pure copper or by keeping the ends non-ferromagnetic.

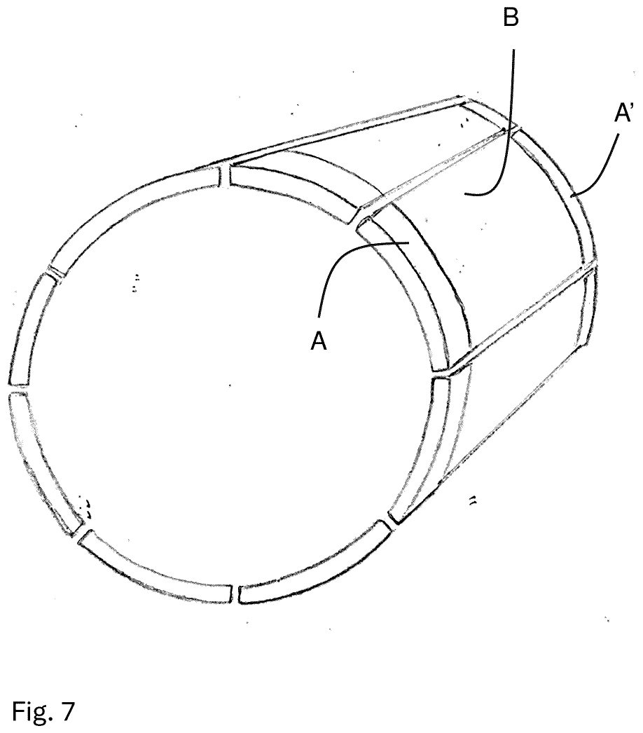

FIG. 7 shows an example embodiment of the present invention in which sections A and A′ of the rotor 2 are defined by low magnetic permeability high conductivity materials, such as copper, for example, while section B may also include materials to enhance magnetic permeability (e.g., ferromagnetic materials).

A further enhancement is to include magnetic material in the rotor layer to strengthen the flux field. For example, by creating the rotor cylinder from rolled layers of copper sheet/foil and iron nitride is one.

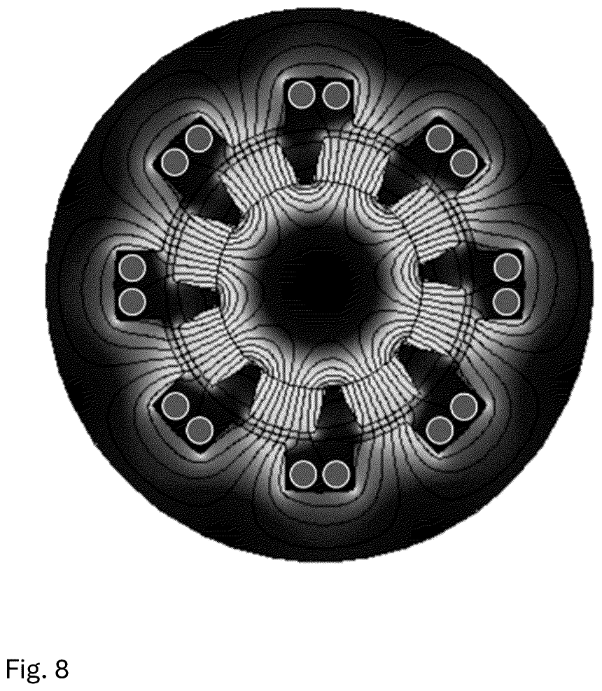

Before moving to the next level of structural enhancement, the concept of “EMF producing percent” will be described. All generators/motors function by moving a properly oriented field relative to a conductive metal to induce EMF and/or torque. In the case of generators such as the one pictured in FIG. 8, the portion where the EMF is created, is shown by the paired circles. This represents about 2 percent of the total volume of the generator, therefore the electroactive percent is 2%. The darker portion of FIG. 8 represents layered silicon steel to conduct the flux. This material accounts for more than 60% of the generator's weight and volume. The lighter square areas show permanent magnets. Accordingly, FIG. 8 shows a FEA diagram of a permanent magnet generator showing that only about 2% of the volume of the generator, the paired small circles, is the portion where EMF/electricity/torque is induced.

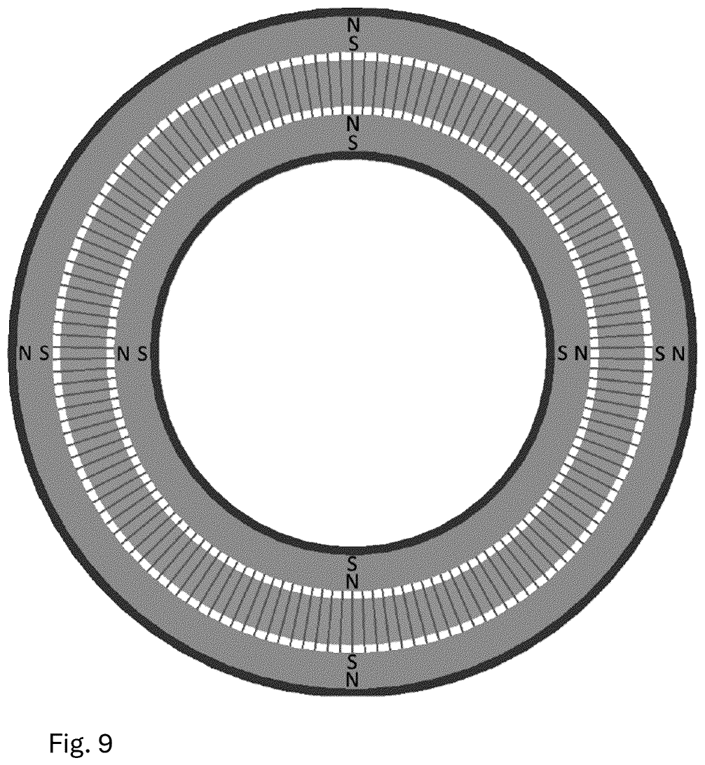

In a drum homopolar structure of example embodiments of the present invention, the electroactive percent is much higher. For example, FIG. 9 depicts a drum homopolar cross section showing that the rotor area, where electricity is induced, is about 30% of the volume in this case.

In the next example embodiments, the layers have combined rotor and stator functions, rather than having stator layers that make the magnetic field and rotor layers that harvest the induction of torque or EMF from the field. The layers are composed of magnets created with enhancements to confer suitably high electrical conductivity. In this way, the magnets function as stators because they contribute the magnetic field (i.e., the produce a magnetic field that is “static” regardless of whether the individual magnets generating the magnetic field are rotating or not) but also function as rotors because they contribute conductive material moving at right angles to the stationary Faraday paradox field when they rotate about their central axis. As above, different layers/segment sections can be electrically insulated from others so that they can be connected in series and/or parallel with each other. The segments may be coated with an insulating material.

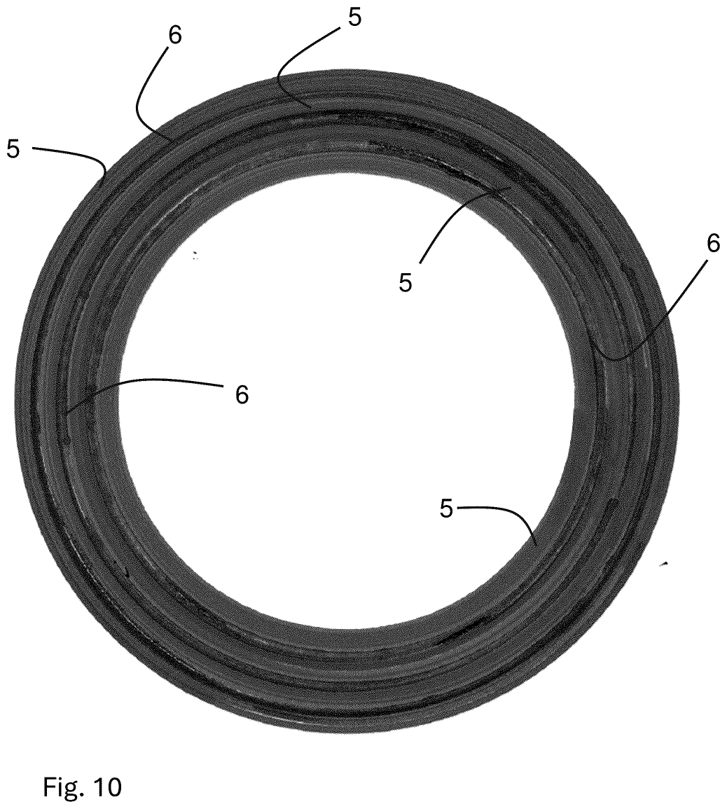

Specifically, FIG. 10 shows a drum-homopolar machine which includes enhanced conductivity hybrid magnet layers 5 that function both as a rotor and a stator and thin film insulation layers 6 that allows the layers to be connected in electrical series, such as, by brushes on either end, rotational electrical connectors, mercury switches, wireless transmission, etc.

Magnets that have suitable electrical conductivity can be, by themselves, homopolar generators. For example a neodymium disc that is axially magnetized and spinning on its north-south axis has conductive material rotating through its stationary magnetic field. Neodymium magnets are about 60% iron. Therefore, when the Neodymium magnet rotates on its North-South axis, the intrinsic iron conductive metal rotates through the powerful “stationary” magnetic field inside the body of the magnet, causing an induced voltage/current towards or away from the center axis of the disk.

Up until now, the internal resistance and the sliding contact resistance, paired with the extremely low voltage/high amperage power signature has kept the expression of the otherwise high wattage produced so low that largely this phenomenon has just been an academic curiosity rather than emblematic of a useful form of power generation.

Even though there may be a tremendous amount of power produced, because the voltage is so low, even tiny amounts of internal and brush resistance can cause the loss of more than 99% of the power produced in such a generator. However, when the composition and architecture of the magnet is altered in novel ways to increase the conductivity with minimal decrease in its magnetic field strength, the measurable output can be orders of magnitude higher. If one then additionally increases the voltage of the system overcoming more of its intrinsic resistances the measured output can be additionally much higher.

Further another example embodiment of the present disclosure corresponds to a dynamoelectric machine which includes a magnetic stator and a conducting rotor which are adhered to one another. As noted above, even when the stator rotates, the magnetic field of the stator still remains stationary due to the Faraday Paradox. Accordingly, the conducting rotor rotates through the stationary magnetic field to generate power.

Further, the magnetic stator itself may be made of a conductive magnet material which rotates through the stationary field. For example, a sintered Neodymium magnets could be used as the stator, with segmented components of a cylinder defining the stator being connected in series. With this arrangement, power is generated in both the rotor and the stator. For example, the conductive magnet material of the stator rotating through the fixed magnetic field produced by the stator will produce a separate power output from a power output produced by the conductive rotor. These two produced powers could be used for different applications, or could be combined through, for example, a transformer.

There are many kinds of permanent magnets which could be used with example embodiments of the present invention. The main categories include Ferrite, Samarium cobalt, Alnico, and Neodymium. For the purposes of this disclosure, iron nitride magnets should especially be also considered. Each of these classes of magnets has a different general electrical conductivity. Ferrite magnets can have such low conductivity they can be considered to be insulators. Neodymium magnets have moderate conductivity, but still too low, without alteration, to demonstrate the actual generating potential. Each type of magnet needs the conductivity enhanced to be effective solo generators.

There are many ways in which a magnet's electrical conductivity can be increased with minimal effect on magnetic strength. Conventionally available neodymium magnets, for example, are frequently coated with a thin metallic surface film to prevent corrosion. Some thin-film coatings have the additional advantage of increasing the surface conductivity of the magnet. Such material can be also included within the body of the magnet, such as in layers, a conductive scaffolding, meshed woven layers, filaments, a shaped armature reinforcement, binder and the like to gain additional conductivity and its benefits.

Various methods of producing magnets with the increased electrical conductivity include 3D printing with the inclusion of conductive architecture made of conductive material such as copper or silver or the like. These structures can be fine filaments and layers, etc. The filaments, layers, etc. can be oriented longitudinally along the path of current flow in a generator, and perpendicularly to the rotor spin for motors for advantageous electrical conductivity anisotropy. Doing so also aids motor applications to produce torque more efficiently as the applied current experiences a resistance to circumferential rotation in the rotor layer. Dividing the rotor into appropriately shaped segments also aids with that. An example of appropriate shapes in a cylinder is longitudinal segments in a cylinder and wedge shaped.

Another example of a manufacturing technique would be to have, for example, a copper mesh or framework installed inside a mold that is then filled with the powdered magnetic material such that, upon sintering or curing, the conductive architecture is embedded within the magnetic material. The magnetic materials are added and sintering parameters including temperature, pressure and time are modified to create the green magnet structure without disrupting the electrical conductivity continuity of the conductive components and reduce the conductive elements undesirably alloying with the magnetic materials.

Chief among these process alterations is lowering the temperature, increasing the pressure and/or increasing the sintering time. The goal is to maximize the opportunity presented by the difference in melting points between the neodymium alloy and the conductivity enhancing material to create the solid magnet with the embedded conductive architecture without allowing undue alloying of the two categories of material. In the case of copper, that delta is relatively small. Copper alloys and alternatives such as aluminum and silver, though have a larger delta melting point so a greater range of sintering conditions can be used without concern for inadvertently causing undesired alloying.

Another usable manufacturing method would be to mix the magnet material powder with a conductive material in powder form and of sufficient concentration to give a relative continuity of the conductive material upon light sintering. If the conductive material has a sufficiently lower melting point than the magnetic material, the conducting material can be used at a high enough concentration and sufficiently melted and sintered to provide a binding substrate in which the magnetic material is embedded or adhered.

In another example of manufacturing techniques, thin films, thin film strips, filaments, mesh, etc. of conductive material are interposed between layers of magnet material.

Because this form of enhanced conductivity of the output of the generator is massively high in amperage but extremely low in voltage, the conductivity enhancements reduce the electrical resistivity inside the magnets allowing for a much greater expression of the induced power.

Starting with a magnet that has been caused to have a greater conductivity, then segmenting it, insulating the segments, and electrically connecting all or some of those segments in series increases the voltage, thus reducing the resistance loss percent.

Working from these advantages, generators can be created that are essentially, by volume and mass, both nearly 100% magnet material, and also nearly 100% electroactive conductive rotor material simultaneously. (Excluding yoke, brushes, connections, insulation)

The novel conductivity enhanced magnets function as both the stator and the rotor simultaneously. Nearly 100% of the device, excluding brushes, yoke, etc. is magnetic and is simultaneously also an electroactive rotor in which EMF is induced. The only space that is not simultaneously both magnet and rotor is the thin insulating layer.

In addition, the field is being utilized inside the magnet where it is the strongest as opposed to outside the magnet in all other generators and motors.

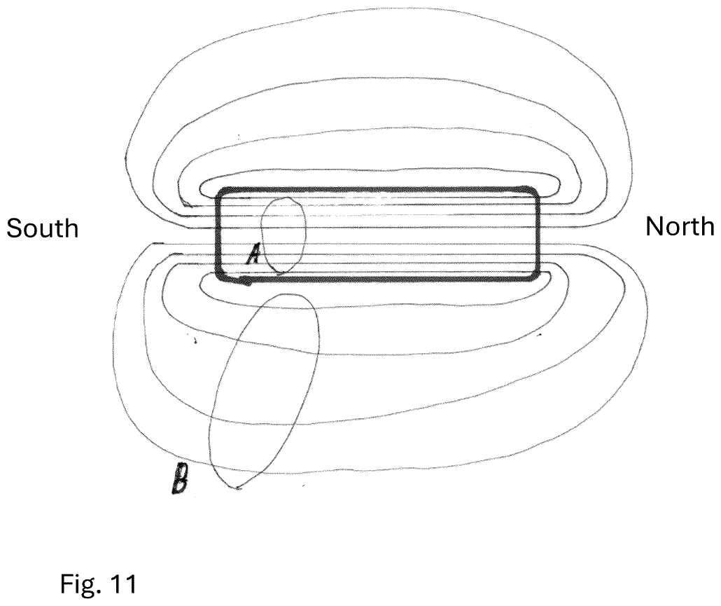

FIG. 11 shows that with respect to a bar magnet, flux lines are continuous loops that pass through the body of the magnet. Inside the magnet (A) the field is at its greatest concentration. Outside the magnets, the flux spreads out (B), diluting itself, creating a weaker field. The field is most concentrated inside the magnet.

Advantages of this arrangement include that the electroactive percent of the stator/rotor complex is near 100% of the volume (nearly 100% is magnet AND 100% is also rotor), but also the portion of the field that is being harvested is the portion internal to the magnet where the field is the strongest. This is in stark contrast to conventional generators and motors wherein the diffuse, bulging external portion of the magnetic field is typically the only portion that is utilized. This confers additional improvements in the power to weight ratio.

Generators and motors can be created that are monolithic, impervious to wear, and much smaller, lighter and less expensive. They utilize the magnets so efficiently there can be less reliance on rare earth materials, and manufacturing is vastly simplified.

It should be understood that the foregoing description is only illustrative of example embodiments of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. A homopolar dynamoelectric machine comprising:
a hollow tube with an empty center;
stator layers spaced radially apart from one another and housed within the hollow tube; and
at least one rotor layer provided within the hollow tube adjacent to the stator layers, and structured to rotate through a magnetic field generated by the stator layers; wherein
the at least one rotor layer and the stator layers are integrally connected to be rotatable together about a central axis of the hollow tube.

2. The homopolar dynamoelectric machine according to claim 1, wherein the at least one rotor layer includes electrically distinct sections which are separated from one another.

3. The homopolar dynamoelectric machine according to claim 2, wherein ones of the electrically distinct sections are electrically connected to one other in series and/or parallel.

4. The homopolar dynamoelectric machine according to claim 2, wherein each of the electrically distinct sections include multiple portions defined by materials with different magnetic permeabilities.

5. The homopolar dynamoelectric machine according to claim 2, wherein the electrically distinct sections each include layers of copper and iron.

6. The homopolar dynamoelectric machine according to claim 2, wherein the electrically distinct sections are defined by individual longitudinally extending segments of a cylinder which are electrically insulated from one another except for being electrically connected in series and/or parallel.

7. The homopolar dynamoelectric machine according to claim 1, wherein
the stator layers and the at least one rotor layer define a first generator; and
additional stator layers and at least one additional rotor layer are provided in the empty center, the additional stator layers and the at least one additional rotor layer define a second generator.

8. The homopolar dynamoelectric machine according to claim 7, wherein
the second generator is structured to have an operating power generation range which peaks at a different RPM than that of the first generator.

9. The homopolar dynamoelectric machine according to claim 7, wherein
the second generator is structured to output power with an opposite polarity from power output by the first generator.

10. The homopolar dynamoelectric machine according to claim 1, wherein
four of the stator layers are provided within the hollow tube; and
the at least one rotor layer includes three rotor layers provided within the hollow tube.

11. The homopolar dynamoelectric machine according to claim 1, wherein
the stator layers and the at least one rotor layer are provided together in enhanced conductivity hybrid magnet layers; and
the enhanced conductivity hybrid magnet layers are separated from one another by thin film insulation layers.

12. The homopolar dynamoelectric machine according to claim 1, wherein
the stator layers include permanent magnets which produce a fixed magnetic field; and
the at least one rotor layer includes a conductive portion that is rotatable through the fixed magnetic field to produce an electric current.

13. The homopolar dynamoelectric machine according to claim 12, wherein the permanent magnets are iron nitride magnets.

14. The homopolar dynamoelectric machine according to claim 1, wherein the stator layers are fixed to the at least one rotor layer.

15. The homopolar dynamoelectric machine according to claim 1, wherein a radially inner one of the stator layers has stronger magnetic properties than a radially outer one of the stator layers.

16. The homopolar dynamoelectric machine according to claim 1, wherein
axially upper and axially lower ends of the at least one rotor layer are pure copper; and
axially inner portions of the at least one rotor layer include a ferromagnetic material and copper.
